(19) United States
(12) Patent Application Publication
(10) Pub. No.: US 2016/0055181 A1
(43) Pub. Date: Feb. 25, 2016

(54) CALCULATING WEIGHT FOR MEDIA BASED ON SOCIAL RELEVANCE

(71) Applicant: HEWLETT-PACKARD DEVELOPMENT COMPANY, L.P., Houston, TX (US)

(72) Inventors: OTAVIO CORREA CORDEIRO, SAN FRANCISCO, CA (US); ANA-PAULA SALENGUE SCOLARI, ROSEVILLE, CA (US); ANDRE DA FONTE LOPES DA SILVA, PALO ALTO, CA (US); DAVID RINALDI, SAN FRANCISCO, CA (US); DIEGO FERREIRA CUNHA DE MAGALHAES, SAO PAULO (BR); FERNANDA FORLAN, PORTO ALEGRE (BR)

(73) Assignee: HEWLETT-PACKARD DEVELOPMENT COMPANY, L.P., Houston, TX (US)

(21) Appl. No.: 14/784,154

(22) PCT Filed: Apr. 30, 2013
(86) PCT No.: PCT/US13/38875

§ 371 Date: Oct. 13, 2015

(51) Int. Cl. G06F 17/30

(52) U.S. Cl. CPC G06F 17/30268; G06F 17/3053; G06F 17/30554

(57) ABSTRACT

Examples disclose a method, executable by a computing device to calculate a weight for a media based on a social relevance of the media. The social relevance includes a number of interactions with the media. Also, the examples disclose the method provides the media displayable in a manner according to the calculated weight.

### BACKGROUND

A social networking service is a type of service which enables users to connect and interact with others users over the Internet. The users may utilize the social networking service to share media, such as images, video, and audio, for interactions among the users.

### BRIEF DESCRIPTION OF THE DRAWINGS

In the accompanying drawings, like numerals refer to like components or blocks. The following detailed description references the drawings, wherein:

FIG. 1 is a block diagram of an example apparatus to obtain multiple images with interactions, a weighting module to calculate a weight for each image, and for outputting the multiple images in as manner consistent with the calculated weight;

FIG. 2A is a diagram of an example image for identifying a minimum number of interactions associated with one of multiple images:

FIG. 2B is a diagram of an example image for identifying a maximum number of interactions associated with one of multiple images;

FIG. 2C is a diagram of an example mosaic view with multiple images, each image provided in a manner according to a calculated weight;

FIG. 3 is a flowchart of an example method to calculate a weight for a media based on social relevance and provide the media in a displayable manner according to the calculated weight;

FIG. 4 is as flowchart of an example method to calculate a weight for a given image based on social relevance by obtaining multiple images and identifying a number of maximum and minimum interactions with one of the multiple images, the example method is further to display the multiple images in a mosaic view according to a calculated weight for each image; and

FIG. 5 is a block diagram of an example computing device with a processor to obtain multiple images, determine a weight corresponding to each image by determining a number of interactions, and providing each image to display in accordance with the determined weight.

### DETAILED DESCRIPTION

In a social networking service, a user may include media associated to their account. Media, as described herein, includes images, audio, text, and/or video that may be shared among multiple individuals in social networking. In this manner, users may view their own images and those of other users, but these images may not be presented in a user-friendly manner by differentiating the various images according to a social relevance. For example, it may be difficult for the user to pay attention to every image in a myriad of images, creating a loss of aesthetic appeal of the images. These images may be presented in the same manner with the same size and dimensions. Other web services may present the images to the user in a grid like fashion, but the grid like fashion does not use social relevance to determine how to display the images the user.

To address these issues, examples disclosed herein provide a method to calculate a weight for a media based on a social relevance of the media. The social relevance includes a number of interactions with the media. The method also provides the media displayable in a manner according to die calculated weight. Providing media displayable based on the social relevance enables a user-friendly and efficient approach to view the more socially relevant media.

Additionally, providing the media to displayable in the manner according to the calculated weight, presents media in a more aesthetic appealing manner. For example, the media may be displayed in a larger size or a smaller size depending on the calculated weight. This enables the user to focus their attention on the more socially relevant images as these images would be presented in a larger size. In another implementation, the media may be displayed in a position corresponding to the calculated weight. For example, the higher calculated weight may be presented in as front and center position rather than the lower calculated weight media may be included in the background. This example creates additional efficiency as the user may focus on the front and centered position.

In another example, the media includes multiple images and the method displays the multiple images in a mosaic view. The multiple images may be associated with a user account on a social networking service or may include a set of images from multiple users associated with the social networking service. Presenting these multiple images in the mosaic view provides an artistic and creative element to displaying the multiple images. This artistic approach may also be customizable as the multiple images may be presented based on the more socially relevant images from multiple users or the more socially relevant images associated with the user.

In a further example, the number of interactions of the social relevance includes the number of comments and/or the number of indications of favorability. Using the number of comments and/or indications of favorability provides a mechanism to measure the social relevance associated with the media. This measurement enables multiple user interactions with the media to determine how socially relevant a given media is.

Examples disclosed herein provide an efficient and aesthetically appealing experience in presenting various media based on a social relevance of the media in a social networking service. Additionally, the examples disclosed herein provide an artistic approach to displaying media based on the social relevance.

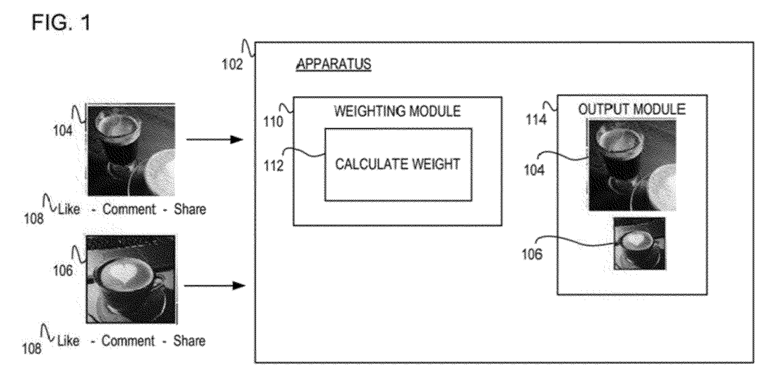

Referring now to the figures, FIG. 1 is a block diagram of an example apparatus 102 to obtain multiple images 104 and 106 associated with interactions 108. The apparatus 102 includes a weighting module 110 to calculate a weight at module 112 for each image 104 and 106. Additionally, the apparatus 102 includes an output module 114 for outputting each of the multiple images 108 and 106 in a manner consistent with the calculated weight at module 112. Specifically, the apparatus 102 is an electronic device that is capable of carrying out tasks and operations which includes receiving multiple images 104 and 106 and calculating a weight for each of the multiple images 104 and 106. As such, implementations of the apparatus 102 include a client device, personal computer, laptop, mobile device, tablet, or other electronic device capable of calculating the weight for each image 104 and 106. Implementations of the apparatus 102 should not be limited to those illustrated in FIG. 1, as the apparatus 102 may further include a processor (not illustrated) to calculate the weight for each of the multiple images 104 and 106.

The multiple images 104 and 106 are representations of media associated with the user of a networking service. Specifically, in FIG. 1, the multiple images 104 and 106 are a type of media specific to a user's account on the networking service. Although FIG. 1 depicts the multiple images 104 and 106 as visual representations, implementations should not be limited as this was done for illustration purposes rather than limiting purposes. For example, in other implementations, the multiple images 104 and 106 include media, video, audio, text or other type of representation specific to the user of the networking service. In further example, the multiple images 104 and 106 may be specific to multiple users of the networking service. The multiple images 104 and 106 may be obtained by the apparatus 102 through an application programming interface (API). The API is source code intended to be used as an interface to communicate between components associated with the apparatus 102 and/or a networking service (not illustrated). In another implementation, the apparatus 102 may request the multiple images 104 and 106 from the networking service.

The interactions 108 represent a social relevance of each of the images 106 and 108. In this manner, the apparatus 102 obtains the multiple images 104 and 106 and calculates the weight at module 112 based on the social relevance. The interactions 108 provide a mechanism through which the apparatus 102 may determine the more popular images by calculating the weight at module 112. The interactions 108 include the interactions between the user of the networking service and other users of that networking service. In this manner, the interactions 108 include indications of favorability and comments. For example, the interactions 108 may include the number of times users of the networking service comments on one of the images 104 and 106. In another example, the interactions 108 may include the number of times users of the networking service may indicate favorability of the image through a symbol representing such favorability, such as liking the image, favoriting the image, loving the image, etc. Using the interactions 108 associated with each image 106 and 108, the apparatus 102 may determine the more popular images tor rendering. The interactions 108 may be transmitted as metadata associated with each image to the apparatus 102.

The weighting module 110 obtains each of the multiple images 104 and 106 for calculating the weight for each image 104 and 106 at module 112. The weighting module 110 may include instructions with each of the images 104 and 106 transmitted to the output module 114 on how to render the multiple images 104 and 106. Implementations of the weighting module 110 include a set of instructions, instruction, process, operation, logic, algorithm, technique, logical function, firmware, and or software executable by a processor (not illustrated) to calculate the weight at module 112.

At module 112 the weight is calculated for each of the multiple images 104 and 106. The weight at module 112 involves emphasizing contributions related to social relevance (e.g., comments and indications of favorability) to achieve a value. That is, rather than each criteria contributing equally, some are adjusted to contribute more than others. Calculating the weight at module 112 for each of the multiple images 104 and 106 enables each image to be displayed in accordance with the calculated weight. For example, one of the multiple images 104 and 106 may be more popular as according to the higher value of interactions, thus that image may be displayed in a front and center fashion or in a larger size than the other image 104 or 106. In one implementation, the module 112 identifies a number of interactions 108 associated with one of the images 104 or 106. In another implementation the module 112 may identify a maximum number of interactions associated with one of the multiple images 104 or 106 and a minimum number of interactions associated with one of the multiple images 104 or 106. This implementation is described in detail in a later figure. Implementations of the module 112 include a set of instructions, instruction, process, operation, logic, algorithm, technique, logical function, firmware, and or software executable by a processor (not illustrated) to calculate the weight of each image 104 and 106.

The output module 114 outputs media, such as the multiple images 104 and 106, in a manner according to the weight calculated at module 112. The output module 114 operates as an interface between the apparatus 102 and the modules 110-112 to instruct an operating system (not illustrated) how to render the various media. The output module 114 may further include instructions on how to render and/or display the media, such as the images 104 and 106. For example, the output module 114 may identify a type of media to be displayed (e.g., text, image, etc) and a position and/or size of the object to be displayed (e.g., X-Y coordinates). As such, implementations of the output module 114 include a display, speaker, screen, or other type of output to render and/or display the multiple media, such as the images 104 and 106. In one implementation, the output module 114 is formatted according to an Application Programming Interface (API). The API is source code intended to be used as an interface to communicate between components associated with the apparatus 102 and/or a networking service (not illustrated). In another implementation, the output module 114 displays the multiple images 104 and 106 in a mosaic view, each of the images 104 and 106 sized and placed in a position according to the calculated weight at module 112. This implementation is described in detail in later figures.

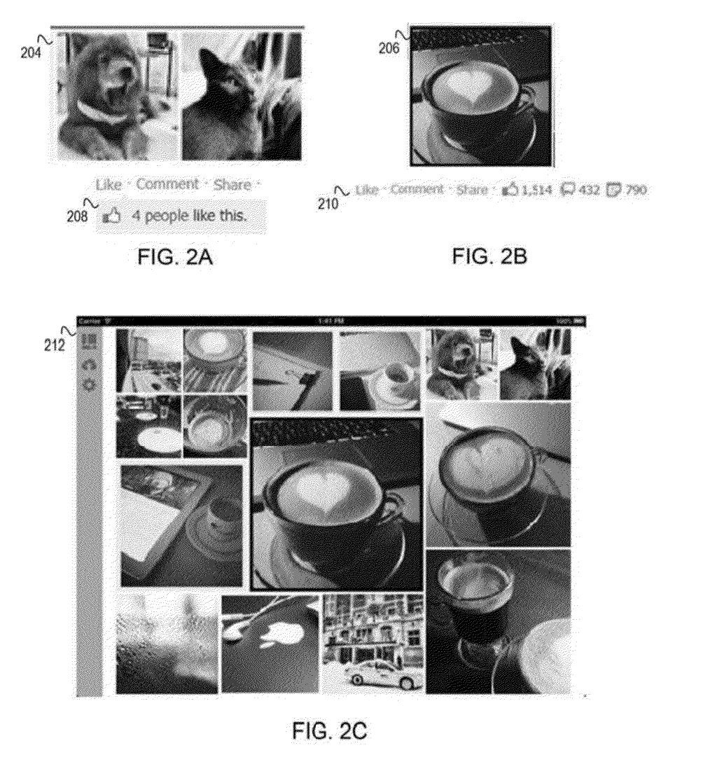

FIG. 2A is a diagram of an example image 204 to identify a minimum number of interactions 208 associated with the image 204. The interactions 208 include users of a networking service that interact with the image 204. The interactions 208 are included as part of the social relevance, so there is a direct correspondence between the social relevance and the interactions 208. For example, the more interactions 208, the more socially relevant the image 204. The interactions 208 include comments and indicators of favorability among the users of the networking service. The comments may include text, audio, and/or images among the users with regards to the given image 204. In one implementation, the image 204 may be shared to other users of the networking service indicating favorability. In another implementation, the indications of favorability may include a symbol representing that at least one of the users of the networking service demonstrating a type of approval of that image 204. For example, the image 204 of the dog and the cat may be considered less socially relevant than an image 210 in FIG. 2B as indicated with the thumbs up symbol. In this example, around four users have indicated favorability as opposed to the image 206 which indicates over a thousand users have indicated favorability. The number of these interactions may be used to calculate the weight as described in relation to FIG. 2C.

FIG. 2B is a diagram of an example image 206 for identifying a minimum number of interactions 210 associated with the image 206. The minimum number of interactions 210 may be identified from metadata associated with the image 206 to calculate the weight. In FIG. 2B, the image 206 may be considered more socially relevant than the image 204 as indicated by the interactions 208 associated with each of the images 204 and 206.

FIG. 2C is a diagram of an example mosaic view 212 including images 204 and 206, each of these images 204 and 206 provided in a manner according to a calculated weight. The mosaic view 212 represents an assemblage of multiple images include 204 and 206. Each of these images are displayed in a manner according to the calculated weight. The manner of displaying each image may include a size and/or position of each image within the mosaic 212. For example, the more socially relevant picture 210 is displayed in a larger size and in as more centered position of the mosaic 212 over the lesser socially relevant picture 208. The mosaic 212 displays each of the multiple images including 204 and 206, in the manner consistent with the calculated weight. For example, assume the various calculated weights for four different images would include the following set {1, 3, 4, 5}, thus the weight of {5} would have a larger sized image than the weight of {1}.

Each of the multiple images 204 and 206 has its weight calculated to determine where and how to display in the mosaic view 212. In one implementation, Equation 1 as below, calculates the weight of one of the given images 204 or 206 using the indications of favorability. As indicated in Equation 1, to calculate the weight for a given image, “W,” is a number of features used in the mosaic view 212. The number of features may include the number of different positions and/or the number of different sizes of images. The other variables in Equation 1 include the following: “P,” represents the number of favorable indications for that given picture; “1,” is the minimum number of favorable indications of one of the multiple images; and “m,” is the number of the maximum number of favorable indications of one of the multiple images.

$$weight = round ( \frac{( W - 1 ) ( P - l )}{m - l} + 1 ) \qquad Equation ( 1 )$$

For example, consider the mosaic view to include five different sizes of images (W=5) with the given number of indications of favorability for the given image may include 73 indications of favorability (P=73) and using the minimum number of indications of favorability (1=4) in FIG. 2A and the maximum number of indications of favorability (m=1,514) as in FIG. 2B. The calculated weight using Equation 1 for the image with 73 would be around 1.182, thus rounding this number the weight=1.

In another implementation, Equation 2 as below, calculates the weight of the given image using the number of indications of favorability and the number of comments. Additionally, Equation 2 uses the mechanism to emphasize and de-emphasize both the number of indications of favorability and the number of comments. Equation 2 uses the following variables to calculate the weight for the given image: “W,” is the number of features used in the mosaic display 212, “l₁,” is the minimum number of favorable indications of one of the multiple images; “m₁,” is the maximum number of favorable indications of one of the multiple images; “L” is the number of favorable indications for the given image; “I_{c},” represents the value of the number of comments of the image containing the fewest comments; “m_{c},” represents the value of the number of the comments of the image containing the most number of comments; and “C,” is the value of the number of comments of the given picture. The parameters, and “α,” and “β,” are used as mechanisms to emphasize and de-emphasize the proportion of the indications of favorability and the proportion of the comments, respectively. Further, in another implementation, the value of the parameters, “α,” and “β” may not exceed one.

$$weight = round ( α \frac{( W - 1 ) ( L - {l}_{l} )}{{m}_{l} - {l}_{l}} + β \frac{( W - 1 ) ( C - {l}_{c} )}{{m}_{c} - {l}_{c}} ) \qquad Equation ( 2 )$$

In keeping, with the previous example, consider five different sizes of images (W=5) with the given number of indications of favorability for the given image may include 73 indications of favorability (L=73) and using the minimum number of indications of favorability (l₁=4) in FIG. 2A and the maximum number of indications of favorability (m₁=1,514) as in FIG. 2B. Additionally, assume the number of comments for the given picture is two (C=2), using the minimum number of comments (l_{c}=0) as in FIG. 2A, and the maximum number of comments (m_{c}=432). Further, assume the parameters of comments may be greater (i.e., β=0.9) than the indications of favorability (α=0.3). The calculated weight using Equation 2 for the image with 73 would be around 0.0716 thus rounding this number the weight=0.

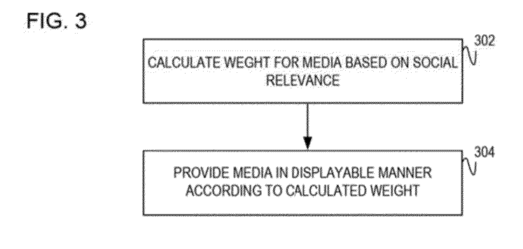

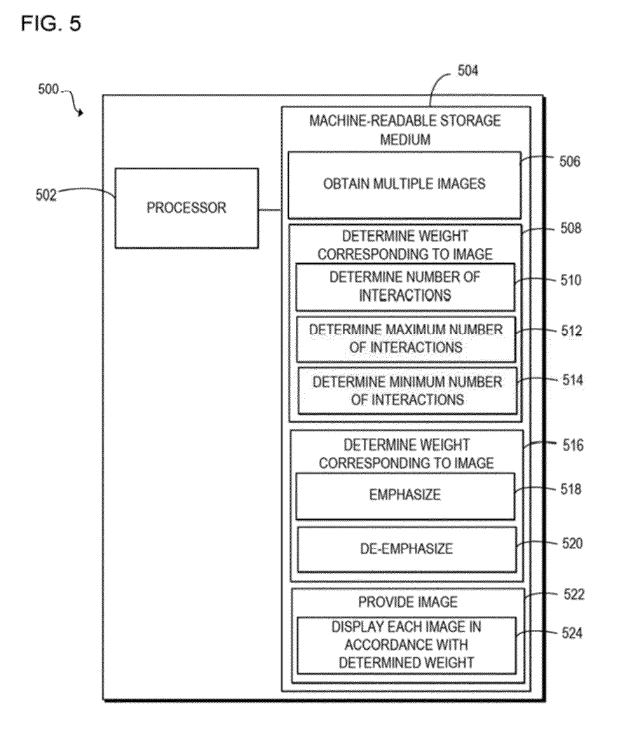

FIG. 3 is a flowchart of an example method to calculate a weight for a media based on social relevance and provide the media in a displayable manner according to the calculated weight. In discussing FIG. 3, reference ma be made to components in FIGS. 1-2C to provide contextual examples. Further, although FIG. 3 is described as implemented by a computing device, it may be executed on other suitable components. For example, FIG. 3 may be implemented in the form of executable instructions on a machine readable storage medium, such as machine-readable storage medium 504 as in FIG. 5. In a further example, FIG. 3 may be implemented by the apparatus 102 as in FIG. 1.

At operation 302, the computing device calculates the weight for the media. The weight is based on a social relevance which includes a number of interactions with the media. The media may include video, audio, and/or images. In one implementation, operation 302 obtains multiple media. In a further implementation, operation 302 obtains the number of interactions associated with each media to calculate the weight. The number of interactions associated with the media may include a number of indications of favorability and/or a number of comments. Using the number of indications of favorability and/or comments provides a mechanism to determine a more popular image (i.e., higher number of interactions) to a less popular image (i.e., as lesser number of interactions).

At operation 304, the computing device provides the media which is displayable in a manner according to the calculated weight as at operation 302. In one implementation, operation 304 displays the media in a size proportional to the calculated weight. For example, if the calculated weight for a given image has a higher calculated weight value than other images, that given image may be sized in a larger size than the other images. In another implementation, operation 304 displays the multiple images obtained at operation 302 into a mosaic view. The mosaic view is a creation of an overall image using assemblage of each of the multiple images.

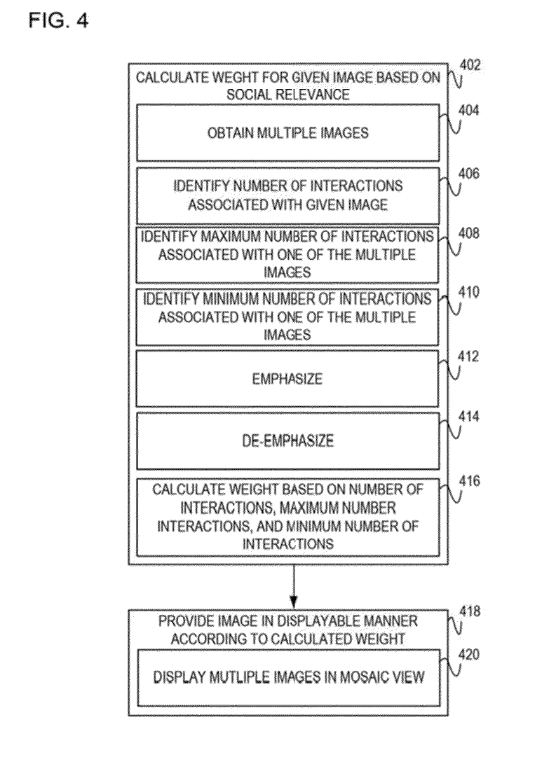

FIG. 4 is a flowchart of an example method to provide to calculate as weight for a given image based on social relevance by obtaining multiple images, identifying a number of maximum and minimum interactions with one of the multiple images, and displaying the multiple images in a mosaic view according to a calculated weight for each image. In one embodiment, to calculate the weight for the given image, the method may identify a number of interactions for the given image, a maximum number of interactions associated with one of the images, and a minimum number of interactions associated with one of the images. In another embodiment, to calculate the weight for the given image, the method emphasizes either a number of indications of favorability or a number of comments and de-emphasizes either the number of indications of favorability or the number of comments. In discussing FIG. 4, reference may be made to components in FIGS. 1-2C to provide contextual examples. Further, although FIG. 4 is described as implemented by a computing device, it may be executed on other suitable components. For example, FIG. 4 may be implemented in the form of executable instructions on a machine readable storage medium, such as machine-readable storage medium 504 as in FIG. 5. In a further example, FIG. 4 may be implemented by the apparatus 102 as in FIG. 1.

At operation 402, the computing device calculates as weight for a given image based on a social relevance of the given image. In one implementation, to execute operation 402, the computing device may execute operations 404-416. Operation 402 may be similar in functionality to operation 302 as in FIG. 3.

At operation 404, the computing device obtains multiple images. The given image as at operation 402 is included as part of the multiple images. In one implementation, the multiple images are obtained as associated with a particular user of a networking service. In another implementation, the multiple images are obtained through an application programming interface (API) from a social networking service. In operation 404, the computing device may request the multiple images as associated with the particular user or the computing device may obtain the multiple images from a storage component associated with the computing device.

At operation 406, the computing device identifies a number of interactions associated with the given image. The multiple images obtained at operation 404 include metadata associated each image. The metadata includes the number of interactions associated with that particular image. The social relevance includes the number of interactions with that given image. The number of interactions may include a number of indications of favorability and/or a number of comments associated with that particular image. For example, the social networking service may transmit each of the multiple images to the computing device. Each of the multiple images is transmitted with corresponding metadata that includes the number of interactions on that particular social networking service. In this example, the calculated weight for each image is specific to that particular social networking service.

At operation 408, the computing device identities as maximum number of interactions associated with one of the multiple images obtained at operation 404. In operation 408, the computing device may process the metadata associated with each of the multiple images to identify the image with the highest number of interactions. In this manner, operation 408 identifies the most popular image from the multiple images as indicated with the number of interactions.

At operation 410, the computing device identifies a minimum number of interactions associated with one of the multiple images obtained at operation 404. The image with the minimum number of interactions is different from the image associated with the maximum number of interactions at operation 408. In operation 410, the computing device may process the metadata associated with each of the multiple images to identify the image with the lowest number of interactions. In this manner, operation 410 identifies the least popular image from the multiple images as indicated with the number of interactions.

At operation 412, the computing devices emphasizes either the number of indications of favorability or the number of comments to calculate the weight for the given image. Emphasizing the indications of favorability or the comments enables an administrator or user decide to weight the criteria of interactions among social networking users accordingly. This provides an additional aspect of customizing the weighting criteria. Depending on whether the indications of favorability or the comments is selected to emphasize, operation 414 de-emphasizes the other criteria which was not selected. For example, assume the administrator wants to weight the number of comments heavier than the indications of favorability, the administrator may also decide to de-emphasize the indications of favorability. This allows the administrator the ability to determine what criteria may be more important to calculate the weight.

At operation 414, the computing device de-emphasizes either the number of indications of favorability or the number of comments based on what emphasized at operation 412.

At operation 416, the computing device calculates the weight based on the number of interactions for the given image at operation 406, the maximum number of interactions with the one of the multiple images at operation 408, and the minimum number of interactions with one of the multiple images at operation 410. In another implementation, the computing device calculates the weight based additionally on the emphasizing and de-emphasizing at operations 412-414.

At operation 418, the computing device provides the given image which is displayable in a manner according the calculated weight at operations 402-416. Operation 418 may be similar in functionality to operation 304 as in FIG. 3.

At operation 420, the computing device displays the multiple images obtained at operation 404 in a mosaic view. The mosaic view is an assemblage of at least one of the multiple images. Each of the multiple images has a calculated weight, so the position and/or size of the each of the multiple images is displayed in the mosaic view according to the weight. For example, an image of a baby may be more popular among other users on the social networking service as indicated with the number of favorable and comments associated with the baby image. An image of coffee may be less popular as there may be fewer interactions among the users of the social networking service. Thus in this example, the baby image may be sized larger and positioned in the center of the mosaic view than the coffee image.

FIG. 5 is a block diagram of an example computing device 500 with a processor 502 to execute instructions 506-524 within a machine-readable storage medium 504. Specifically, the computing device 500 with the processor 502 obtains multiple images and determines a weight corresponding to each image. The weight is based on a social relevance and may be determined by identifying a number of interactions with an image of the multiple images and/or emphasizing and de-emphasizing either a number of indications of favorability or a number of comments. Although the computing device 500 includes processor 502 and machine-readable storage medium 504, it may also include other components that would be suitable to one skilled in the art. For example, the computing device 500 may include a controller to execute instructions 506-524. The computing device 500 is an electronic device with the processor 502 capable of executing instructions 506-524, and as such implementations of the computing device 500 include a computing device, mobile device, client device, personal computer, desktop computer, laptop, tablet, video game console, or other type of electronic device capable of executing instructions 506-524. The instructions 506-524 may be implemented as methods, functions, operations, and other processes implemented as machine-readable instructions stored on the storage medium 504, which may be non-transitory, such as hardware storage devices (e.g., random access memory (RAM), read only memory (ROM), erasable programmable ROM, electrically erasable ROM, hard drives, and flash memory. Implementations of the processor 502 include a controller, microchip, chipset, electronic circuit, microprocessor, semiconductor, microcontroller, central processing unit (CPU), graphics processing unit (GPU), visual processing unit (VPU), or other programmable device capable of executing instructions 506-524.

The processor 502 may fetch, decode, and execute instructions 506-524 for determining the weight for each image among the multiple images. In one implementation, once executing instructions 506-514, the processor 502 may execute instructions 516-24. In another implementation once executing instruction 506-514, the processor 502 may execute instructions 522-524 to display each image in accordance with the determined weight. In a further implementation, once executing instruction 506, the processor 502 may execute instructions 516-524 to determine the weight for each image for display. Specifically, the processor 502 executes instructions 506-514 to: obtain multiple images, determine the weight corresponding to each image by determining a number of interactions with a given image, determining a maximum number of interactions associated with one of the multiple images, and determining a minimum number of interactions associated with one of the multiple images. The processor 502 may then execute instructions 516-520 to: determine the weight corresponding to each image, the weight based on a number of interactions, the weight determined by emphasizing and de-emphasizing either a number of indications of favorability or a number of comments. Once executing instructions 506-514 and/or instructions 516-520, the processor 502 may then execute instructions 522-524 to provide each image and display each image in accordance with the determined weight.

The machine-readable storage medium 504 includes instructions 506-524 for the processor 502 to fetch, decode, and execute. In another embodiment, the machine-readable storage medium 504 may be an electronic, magnetic, optical, memory, storage, flash-drive, or other physical device that contains or stores executable instructions. Thus, the machine-readable storage medium 504 may include, for example, Random Access Memory (RAM), an Electrically Erasable Programmable Read-Only Memory (EEPROM), a storage drive, a memory cache, network storage, a Compact Disc Read Only Memory (CDROM) and the like. As such, the machine-readable storage medium 504 may include an application and/or firmware which can be utilized independently and/or in conjunction with the processor 502 to fetch, decode, and/or execute instructions of the machine-readable storage medium 504. The application and/or firmware may be stored on the machine-readable storage medium 504 and/or stored on another location of the computing device 500.

Examples disclosed herein provide an efficient and aesthetically appealing experience in presenting various media based on a social relevance of the media in a social networking service. Additionally, the examples disclosed herein provide an artistic approach to displaying, media based on the social relevance.

We claim:

1. A method, executable by a conning device, the method comprising:
calculating a weight for a media, by the computing device, based on a social relevance of the media, wherein the social relevance includes a number of interactions with the media; and
providing the media displayable in a manner according to the calculated weight.

2. The method of claim 1 herein the media includes an image and wherein the image is displayable in a size corresponding to the calculated weight.

3. The method of claim 1 wherein the media includes a given image and calculating the weight for the given image based on the social relevance of the media is further comprising:
obtaining multiple images, wherein the given image is included in the multiple images;
identifying the number of interactions for the given image;
identifying a maximum number of interactions associated with one of the multiple images;
identifying as minimum number of interactions associated with one of the multiple images;
calculating the weight for the given image based on the number of interactions for the given image, the maximum number of interactions, and the minimum number of interactions.

4. The method of claim 1 further comprising:
displaying the media in a mosaic view, wherein the media includes multiple images, each image displayed as a size corresponding to a calculated weight for each image.

5. The method of claim 1 further comprising:
obtaining the media through an application programming interface.

6. The method of claim 1 wherein the number of interactions with the media includes the number one of the following: comments associated with the media and indications of favorability associated with the media.

7. The method of claim 1 wherein the number of interactions with the media include comments associated with the media and indications of favorability associated with the media, the method further comprising:
emphasizing one of the number of indications of favorability or the number of comments associated with the media; and
de-emphasizing one of the number of indications of favorability or the number of comments associated with the media.

8. A non-transitory machine-readable storage medium encoded with instructions executable by a processor of a computing device, the storage medium comprising instructions to:
determine a weight corresponding to an image, based on the social relevance of the image, wherein the social relevance includes a number of interactions with the image; and
provide the image displayable in a manner according to the determined weight.

9. The non-transitory machine-readable storage medium including the instructions of claim 8 and further comprising instructions to:
obtain multiple images displayable in a mosaic view; and
size each of the multiple images according to the determined weight, wherein different determined weights indicate different sizes associated with each of the multiple images.

10. The non-transitory machine-readable storage medium including the instructions of claim 8 wherein to determine the weight corresponding to the image, based on the social relevance of the image is further comprising instructions to:
obtain multiple images, wherein the image is included in the multiple images;
determine the number of interactions associated with image;
determine a maximum number of interactions associated with one of the multiple images; and
determine a minimum number of interactions associated with one of the multiple images.

11. The non-transitory machine-readable storage medium of claim 8 wherein the number of interactions include a number of indications of favorability associated with the image and a number of comments associated with the images and further comprising instructions to:
de-emphasize one of the number of indications of favorability or the number of comments associated with the images; and
emphasize one of the number of indications of favorability or the number of comments associated with the image to determine the weight.

12. The non-transitory machine-readable storage medium of claim 8 further comprising the instructions to:
obtain multiple images wherein the image is included in the multiple images;
determine the weight for each image in the multiple images; and
display each image according to the determined weight.

13. An apparatus comprising:
a weighting module to:
obtain multiple images associated with a particular account;
calculate a weight for each of the multiple images based on a social relevance of each of the multiple images, wherein the social relevance includes a number of interactions associated with each of the multiple images;
a output module to provide each of the images displayable in a manner according to the calculated weight for each of the multiple images.

14. The apparatus of claim 13 further comprising:
a display to present each of the multiple images in a mosaic view, wherein each of the multiple images is displayed as a size corresponding to the calculated weight for each of the multiple images.

15. The apparatus of claim 13 wherein the number of interactions associated with each of the images includes a number of one of the following: comments associated with each of the multiple images and indications of favorability associated with each of the images.
